(19) United States
(12) Patent Application Publication
(10) Pub. No.: US 2006/0211655 A1
(43) Pub. Date: Sep. 21, 2006

(54) Repellent

(75) Inventors: Norbert Mencke, Leverkusen (DE); Dorothee Stanneck, Solingen (DE); Andreas Turberg, Haan (DE); Hans Dautel, Berlin (DE)

Correspondence Address: JEFFREY M. GREENMAN, BAYER PHARMACEUTICALS CORPORATION, 400 MORGAN LANE, WEST HAVEN, CT, 06516, US

(73) Assignee: Bayer Health Care ag, Leverkusen (DE)

(21) Appl. No.: 10/541,087

(22) PCT Filed: Jan. 5, 2004
(86) PCT No.: PCT/EP04/00017

§ 371 Date: Apr. 10, 2006

(30) Foreign Application Priority Data
Jan. 17, 2003 (DE) 103 01 906.5

(51) Int. Cl. A01N 65/00

(52) U.S. Cl. 514/65

(57) ABSTRACT

The present invention relates to the use of an arthropod-repelling component from the pyrethroid/pyrethrin class in combination with an agonist of the nicotinergic acetylcholine receptors of arthropods for repelling arthropods, preferably on animals, in an effective and sustainable manner.

The present invention relates to the use of an arthropod-repelling component from the pyrethroid/pyrethrin class in combination with an agonist of the nicotinergic acetylcholine receptors of arthropods for repelling arthropods, preferably on animals, in an effective and sustainable manner.

The use of topical formulations comprising permethrin, (3-phenoxyphenyl)methyl 3-(2,2-dichloroethenyl)-2,2-dimethylcyclopropanecarboxylate, (CAS No [52645-53-1] for controlling parasitic insects on animals is known (cf: for example, WO 95/17 090, JP-07 247 203, EP-A-567 368, EPA-461 962, U.S. Pat. No. 5,236,954 and U.S. Pat. No. 5,074,252).

Agonists of the nicotinergic acetylcholine receptors of insects are known, for example from the European Offenlegungsschriften Nos. 464 830, 428 941, 425 978, 386 565, 383 091, 375 907, 364 844, 315 826, 259 738, 254 859, 235 725, 212 600, 192 060, 163 855, 154 178, 136 636, 303 570, 302 833, 306 696, 189 972, 455 000, 135 956, 471 372, 302 389; German Offenlegungsschriften Nos. 3 639 877, 3 712 307; Japanese Offenlegungsschriften Nos. 03 220 176, 02 207 083, 63 307 857, 63 287 764, 03 246 283, 04 9371, 03 279 359, 03 255 072; U.S. Pat. Nos. 5,034,524, 4,948,798, 4,918,086, 5,039,686, 5,034,404; PCT application Nos. WO 91/17 659, 92/4965; French application No. 2 611 114; Brazilian application No. 88 03 621. The use of spot-on formulations containing agonists or antagonists of the nicotinergic acetylcholine receptors of insects for controlling parasitic insects on animals is likewise known (see, for example; WO 98/27 817, EP-A-682 869 and EP 0 976 328).

Combinations of permethrin with agonists or antagonists of the nicotinergic acetylcholine receptors of insects for combating parasites have also been described in the prior art (cf., for example, CN-1 245 637, WO 00/54 591, U.S. Pat. No. 6,080,796, EP-A-981 955, U.S. Pat. No. 6,033,731, JP-07 089 803). The arthropod-repelling activity of type I pyrethroids was first described in U.S. Pat. No. 4,178,384 (Pyrethroid insect repellent. Ensing, Kenneth J., 1979, U.S. Pat. No. 4,178,384), Matthewson et al. (1981, Screening techniques for the evaluation of chemicals with activity as tick repellents. Matthewson, Michael D.; Hughes, Graham; Macpherson, Ian S.; Bernard, Colette P., Pesticide Science, 12(4), 455-62) and Shemanchuk (1981, Repellent action of perrnethrin, cypermethrin, and resmethrin against black flies (Simulium species) attacking cattle. Shemanchuk, Joseph A., Pesticide Science, 12(4), 412-16) describe the repellent activity of type I and type II pyrethroids against ticks and fleas, respectively.

The disadvantage of the spot-on formulations, for example perrethrin-based spot-on formulations, is their low activity against fleas, midges and flies.

As a rule, spot-on formulations based on agonists and antagonists of the nicotinergic acetylcholine receptors (see, for example, WO 96/17520) have good activity against insects. However, their disadvantage is they are virtually ineffective against ticks and show no tick-repellent activity.

This is why a multiple treatment of the animals with various formulations was required to date for the successful control of ticks and fleas and for repelling midges and flies. For ecological and economical reasons, it is desirable to replace these formulations by others which are well tolerated by the skin, toxicologically acceptable and distinguished further by their good long-term action of at least three to four weeks, especially against ticks, fleas, midges and flies, at a low application volume (for example 0.1 ml/1.0 kg [body weight of the animal to be treated]). Moreover, such a formulation should be sufficiently storage-stable in all climates, usually at least three years for example in the case of the conventional spot-on tubes.

WO 02/087338 describes the provision of a dermatologically and environmentally acceptable, user friendly formulation for dermal application comprising permethrin and agonists or antagonists of the nicotinergic acetylcholine receptors for insects which is active against parasitic insects, in particular against ticks and fleas.

Surprisingly, it has now been found that compositions which contain active compounds from the pyrethroid/pyrethrin group in combination with active compounds which act agonistically at the arthropod nictotine receptor have very good repelling properties against arthropods such as, for example, ticks, midges and flies, which exceed the repellent effect of formulations containing pyrethroid/pyrethrin alone. This relates both to the relative contact times of the ectoparasites with the animal treated and to the contact time required for achieving 100% mortality after contact. As can be seen from comparative in-vitro studies, this effect cannot be attributed to the formulation.

Thus, such combination formulations of the type described in greater detail hereinbelow are not only capable of controlling parasites which have already attacked the animal, but, surprisingly, also prevent very efficiently acute attack and thus the potential transmission of pathogens by arthropods, in particular ticks, midges and sucking flies.

The present invention relates to
1. The use of a pyrethroid or pyrethrin in combination with a nicotinic agonist for repelling arthropods.
2. The use of item 1, wherein the pyrethroid is selected from amongst the following groups:

I. Type I pyrethroids

II. Type II pyrethroids

III. Non-ester pyrethroids

IV. Natural pyrethrins
3. The use under item 1, wherein the nicotinic agonist is selected from amongst the following groups:

V. Neonicotinoids

VI. Nithiazine

VII. Spinosyns
4. The use under item 1 for repelling ticks, fleas, midges and/or flies on warm-blooded species.
5. A method for repelling arthropods from warm-blooded species, in which a pyrethroid or pyrethrin in combination with a nicotinic agonist is applied topically to the warm-blooded animal.
6. A method for repelling arthropods from locations and materials where they are undesired, in which a pyrethroid or pyrethrin in combination with a nicotinic agonist is applied to the location or the material from which the arthropods are to be repelled.

The compositions according to the invention are preferably liquid and suitable for dermal application, in particular as what are known as pour-on or spot-on formulations. Other application forms are feasible (see hereinbelow).

They usually contain the pyrethroid or pyrethrin in the following amounts:
I. Type I pyrethroids such as, for example, permethrin: 15-75% by weight, preferably 33-55% by weight.
II. Type II pyrethroids such as, for example, cypermethrin: 1-20% by weight, preferably 5-15% by weight.
III. Non-ester pyrethroids such as, for example, etofenprox, silafluofen: 15-75% by weight, preferably 40-60% by weight.
IV. Natural pyrethrins such as, for example pyrethrin I, jasmolin I, cinnerin I, pyrethrin II, jasmolin II, cinnerin II: 25-75%, preferably 30-50% by weight.

The compositions which can be used in accordance with the invention contain an active compound from the class of the nicotinic agonists V-VII in the following amounts:
V. Neonicotinoids: 1-25% by weight, preferably 5-15% by weight. Examples which may be mentioned are: imidacloprid, thiacloprid, clothianidin, nitenpyram, dinotefuran, thiamethoxam
VI. Nithiazine 20-40% by weight, preferably 25-35% by weight.
VII. Spinosyns: 1-25% by weight, preferably 5 15% by weight. Examples which may be mentioned here are: spinosad, butyl-spinosad.

Furthermore, the compositions which can be used in accordance with the invention generally contain conventional solvents and spreading agents and, if appropriate, conventional auxiliaries.

The percentages by weight refer to the total weight.

The classification of the pyrethroids/pyrethrins as type I pyrethroids, type II pyrethroids, non-ester pyrethroids and natural pyrethrins is detailed in Encyclopedic Reference of Parasitology 2nd ed., Disease, Treatment, Therapy, (H. Mehlhom ed.), 2001, pages 91-96, which is expressly incorporated by reference.

Examples of type I pyrethroids are allethrin, bloallethrin, permethrin, phenothrin, resmethrin, tetramethrin.

Examples of type II pyrethroids are: alpha-cypermethrin, cyfluthrin, cyhalothrin, cypermethrin, deltamethrin, fenvalerate, flucythrinate, flumethrin, tau-fluvalinate.

Examples of non-ester pyrethroids are, for example, etofenprox, silafluofen.

Examples of natural pyrethrins are pyrethrin I, pyrethrin II, cinerin I, cinerin II, jasmolin I, jasmolin II

Agonists of the nicotinergic acetylcholine receptors of insects which are preferably mentioned are the neonicotinoids.

Neonicotinoids are understood as meaning, in particular, compounds of the formula (I), 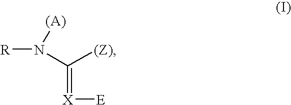
in which:
R represents hydrogen, optionally substituted radicals of the group acyl, alkyl, aryl, aralkyl, heteroaryl, heteroarylalkyl or heterocyclylalkyl;
A represents a monofunctional group from the series hydrogen, acyl, alkyl, aryl, or a bifunctional group which is linked to the radical Z;
E represents an electron—attracting radical;
X represents the radicals —CH═ or ═N—, it being possible for the radical —CH═ to be linked to the radical Z instead of to an H atom;
Z represents a monofunctional group from the series alkyl, —O—R, —S—R, 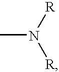
   where
   R represents identical or different radicals and has the abovementioned meaning,
   or Z represents a bifunctional group which is linked to the radical A or the radical X.

Especially preferred are compounds of the formula (I) in which the radicals have the following meanings:
R represents hydrogen and optionally substituted radicals from the series acyl, alkyl, aryl, aralkyl, heteroaryl, heteroarylalkyl, heterocyclylalkyl.
   Acyl radicals which may be mentioned are formyl, (C₁₋₈-alkyl)-carbonyl, (C₆₋₁₀-aryl)-carbonyl, (C₁₋₈alkyl)-sulphonyl, (C₆₋₁₀-aryl)-sulphonyl, (C₁₋₈-alkyl)-(C₆₋₁₀-aryl)-phosphoryl, all of which can, in turn, be substituted.
   Alkyl radicals which may be mentioned are C₁₋₁₀-alkyl, in particular C₁₋₄-alkyl, specifically methyl, ethyl, i-propyl, sec- or t-butyl, all of which, in turn, can be substituted.
   Aryl is, in particular, C₆₋₁₀-aryl, examples which may be mentioned being phenyl, naphthyl, in particular phenyl.
   Aralkyl is, in particular, (C₆₋₁₀-aryl)-(C₁₋₄-alkyl), examples which may be mentioned being phenylmethyl, phenethyl.
   Heteroaryl radicals which may be mentioned are heteroaryl radicals having up to 10 ring atoms and N, O, S in particular N, as hetero atoms. The following may be mentioned specifically: thienyl, furyl, thiazolyl, imidazolyl, pyridyl, benzothiazolyl.
   Heteroarylalkyl is, in particular, heteroaryl-(C₁₋₄-alkyl), where heteroaryl is as defined above. Examples which may be mentioned are heteroarylmethyl, heteroarylethyl having up to 6 ring atoms and N, O, S, in particular N, as hetero atoms.
   Heterocyclyl is, in particular, an unsaturated, but nonaromatic, or saturated heterocycle having up to 6 ring atoms and containing up to 3 hetero atoms selected from amongst N, O, S, for example tetrahydrofuryl.
   Heterocyclylalkyl is, in particular, heterocyclyl-C₁₋₂-alkyl, for example: tetrahydrofuranylmethyl and tetrahydrofuranylethyl.
   Substituents which may be mentioned by way of example and by preference are:
   alkyl having preferably 1 to 4, in particular 1 or 2 carbon atoms such as methyl, ethyl, n- and i-propyl and n-, i- and t-butyl; alkoxy having preferably 1 to 4, in particular 1 or 2 carbon atoms such as methoxy, ethoxy, n- and i-propyloxy and n-, i- and t-butyloxy; alkylthio having preferably 1 to 4, in particular 1 or 2 carbon atoms such as methylthio, ethylthio, n- and i-propylthio and n-, i- and t-butylthio; halogenoalkyl having preferably 1 to 4, in particular 1 or 2 carbon atoms and preferably 1 to 5, in particular 1 to 3 halogen atoms, the halogen atoms being identical or different and the halogen atoms preferably being fluorine, chlorine or bromine, in particular fluorine, such as trifluoromethyl; hydroxyl; halogen, preferably fluorine, chlorine, bromine and iodine, in particular fluorine, chlorine and bromine; cyano; nitro; amino; monoalkyl- and dialkylamino having preferably 1 to 4, in particular 1 or 2 carbon atoms per alkyl group, such as methylamino, methyl-ethyl-amino, n- and i-propylamino and methyl-n-butylamino; carboxyl; carbalkoxy having preferably 2 to 4, in particular 2 or 3 carbon atoms such as carbomethoxy and carboethoxy; sulpho (—SO₃H); alkylsulphonyl having preferably 1 to 4, in particular 1 or 2 carbon atoms such as methylsulphonyl and ethylsulphonyl; arylsulphonyl having preferably 6 or 10 aryl carbon atoms such as phenylsulphonyl, and heteroarylamino and heteroarylalkylamino such as chloropyridylamino and chloropyridylmethylamino.
A especially preferably represents hydrogen and optionally substituted radicals from the series acyl, alkyl, aryl, preferably with the meanings stated for R. A. furthermore represents a bifunctional group. A radical which may be mentioned is optionally substituted alkylene having 14, in particular 1-2 C atoms, where the substituents mentioned may be the substituents enumerated further above and where the alkylene groups can be interrupted by hetero atoms from the series N, O, S.
A and Z jointly with the atoms to which they are bonded can form a saturated or unsaturated heterocyclic ring. The heterocyclic ring can contain 1 or 2 further, identical or different hetero atoms and/or hetero groups. Hetero atoms are preferably oxygen, sulphur or nitrogen and hetero groups are preferably N-alkyl groups, where alkyl of the N-alkyl group preferably contains 1 to 4, in particular 1 or 2 carbon atoms. Alkyl radicals which may be mentioned are methyl, ethyl, n- and i-propyl and n-, i- and t-butyl. The heterocyclic ring contains 5 to 7, preferably 5 or 6 ring members.
   Examples of the heterocyclic ring which may be mentioned are pyrrolidine, piperidine, piperazine, hexamethylenimine, hexahydro-1,3,5-triazine, morpholine and oxadiazine, all of which can optionally be substituted, preferably by methyl.
E represents an electron-attracting radical, radicals which may be mentioned being in particular NO₂, CN, halogenoalkylcarbonyl such as halogeno-C₁₋₄-alkylcarbonyl having 1 to 9 halogen atoms, in particular COCF₃, and C₁₋₄-alkylsulphonyl and halogeno-C₁₋₄ alkylsulphonyl having 1 to 9 halogen atoms, in particular SO₂CF₃.
X represents —CH═ or —N═
Z represents optionally substituted radicals alkyl, —OR, —SR, —NRR, where R and the substituents preferably have the abovementioned meanings.
Z may not only form the abovementioned ring, but, together with the atom to which it is bonded and the radical 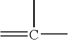
   instead of X, may form a saturated or unsaturated heterocyclic ring. The heterocyclic ring may contain 1 or 2 further, identical or different hetero atoms and/or hetero groups. Hetero atoms are preferably oxygen, sulphur or nitrogen and hetero groups are preferably N-alkyl radicals, where the alkyl or N-alkyl group contains preferably 1 to 4, in particular 1 or 2 carbon atoms. Alkyl radicals which may be mentioned are methyl, ethyl, n- and i-propyl and n-, i- and t-butyl. The heterocyclic ring contains 5 to 7, preferably 5 or 6 ring members.
   Examples of the heterocyclic ring which may be mentioned are pyrrolidine, piperidine, piperazine, hexamethylenimine, morpholine and n-methylpiperazine.

Compounds which may be mentioned as compounds which can be used very especially preferably in accordance with the invention are those of the general formulae (II), (III) and (IV): 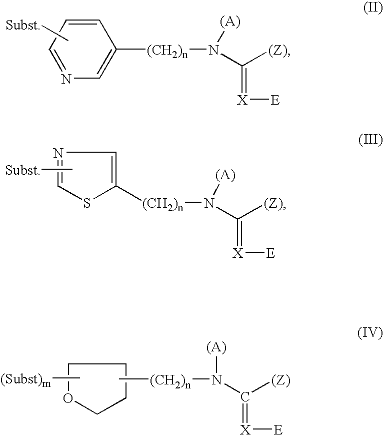
in which
n represents 1 or 2,
m represents 0, 1 or 2,
Subst. represents one of the abovementioned substituents, in particular halogen, very especially chlorine,
A, Z, X and E have the abovementioned meanings.

The following compounds may be mentioned specifically:

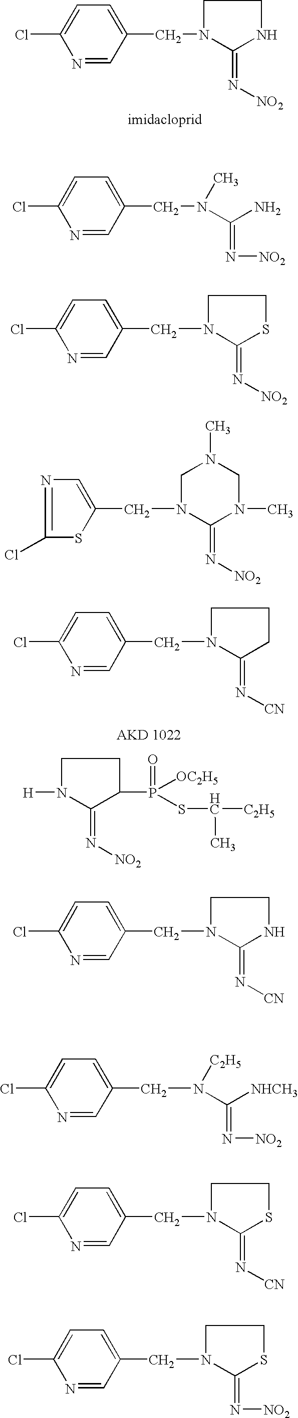

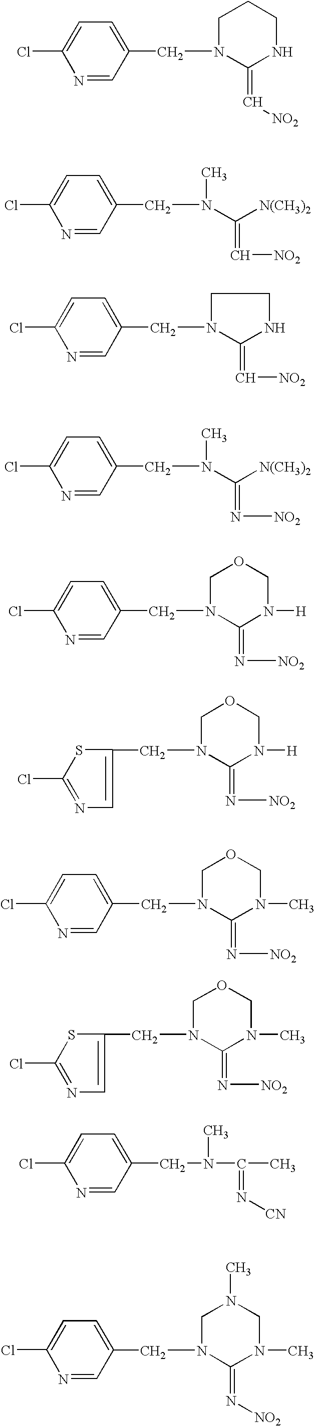

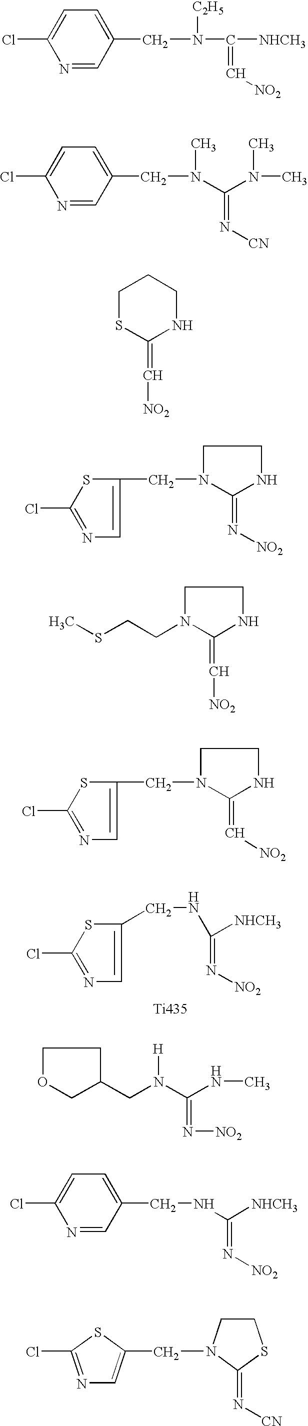

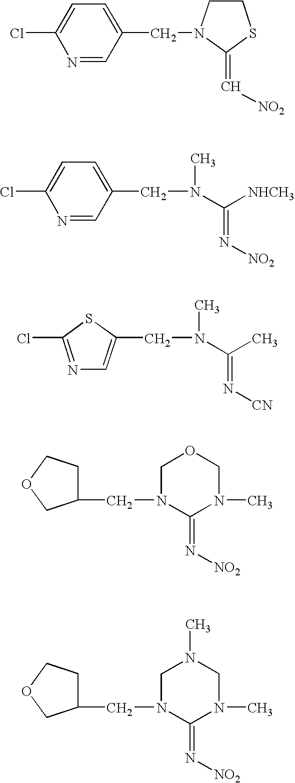

The following especially preferred compounds may be mentioned individually:

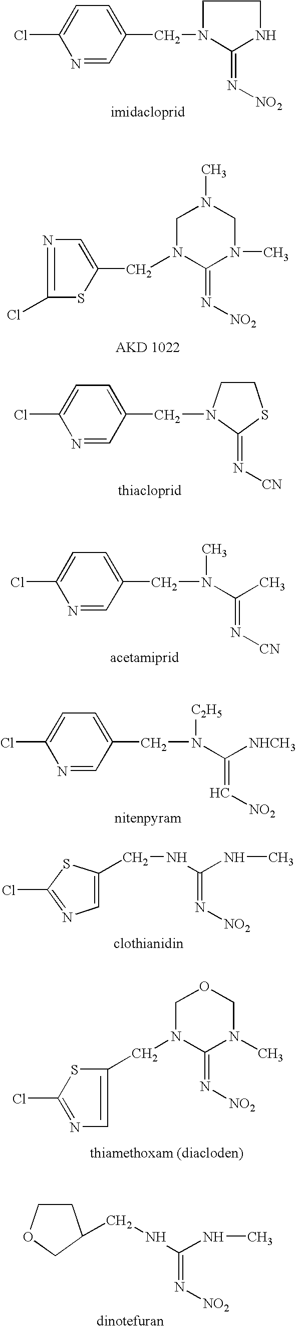

In addition to nicotinic agonists from the neonicotinoid group, other nicotinic agonists may also be used in accordance with the invention.

Examples which may be mentioned in this context are compounds from the spinosyn group, in particular spinosyn A and D 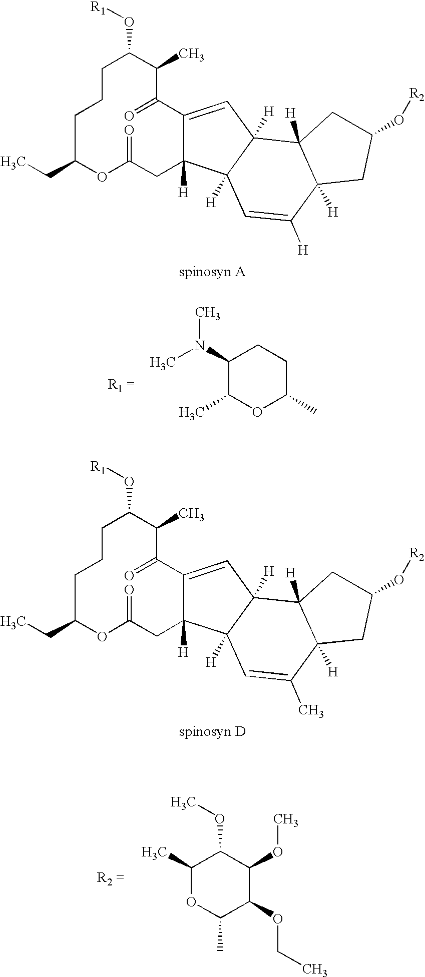
as described in Boeck et al. in EP 375316 A1 and Deamicis et al. in WO 97/00265 A1; the abovementioned documents are expressly incorporated by reference.

In the present context, spinosyns are also understood as meaning synthetic and semnisynthetic derivatives of the natural spinosyns or derivatives which are obtained from genetically modified strains of, for example, Saccharopolyspora species as described in WO 02/77004 and WO 02/77005; the abovementioned documents are expressly incorporated by reference.

Examples which may be mentioned are compounds of the formulae I and II where R³ is a glycoside (R³═R¹), R⁴ is H. OH or alkoxy (usually having 1 to 8, preferably 1 to 4 carbon atoms; R⁵ is H, methyl, R⁶ and R⁷ are H or combined to form a double bond or an epoxy group, R⁸ in formula I is trans-1-butenyl, 1,3-butadienyl, butyl, 3-hydroxy-butenyl, propyl; 1-propenyl, 1,2-epoxy-1-butyl, 3-oxo-1-butenyl, CH₃CH(OCH₃)CH═CH—, CH₃CH═CHCH(CH₂CO₂CH₃)—, or CH₃CH═CHCH[CH₂CON(CH₃)₂]—; R⁹ is H or glycoside (R⁹═R²).

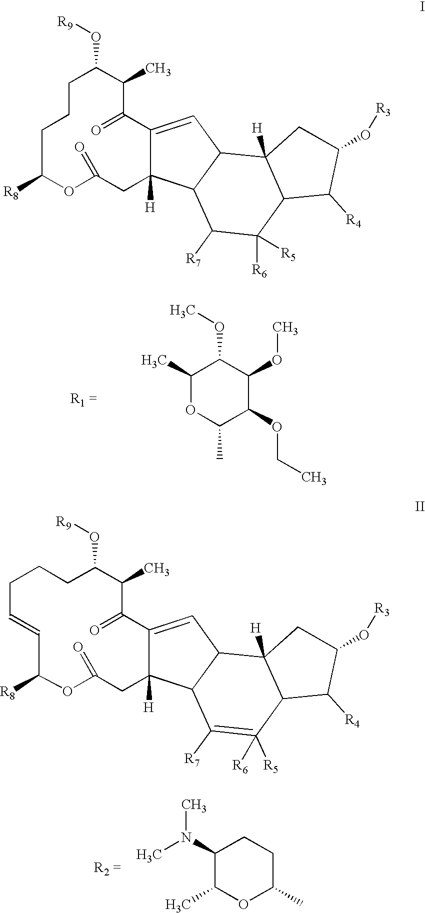

Other compounds which are active as agonists on the nicotinic receptor and which can likewise be combined successfully with compounds from group 1 are, for example, nicotine or nithiazine

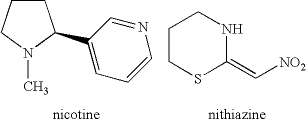

Surprisingly, the repellent effect and the short-contact mortality of the combination used in accordance with the invention, of active compounds from the group of the nicotinic agonist in combination with active compounds from the pyrethroid/pyrethrin group, exceeds what was to be expected on the basis of the activities of the individual components. By using these compositions, it is therefore possible to reduce the application rates of active compound and to prolong the sustained activity. Accordingly, their use has economical and ecological advantages.

The combinations used in accordance with the invention are outstandingly suitable for use in repelling parasites and for preventing the transmission of pathogens which are transmitted by such parasites. The parasites can be repelled directly on humans or animals or in the environment. Moreover, the abovementioned active compound combination can also be used in the protection of materials, namely for repelling arthropods from locations and materials where they are undesired.

Parasites which may be mentioned are:

from the order of the Anoplura, for example, Haematopinus spp., Linognathus spp., Solenopotes spp., Pediculus spp., Pthirus spp.;

from the order of the Mallophaga, for example, Trimenopon spp., Menopon spp., Eomenacanthus spp., Menacanthus spp., Trichodectes spp., Felicola spp., Damalinea spp., Bovicola spp;

from the order of the Diptera, for example, Aedes spp., Culex spp., Simulium spp., Phlebotomus spp., Lutzomyia spp., Chrysops spp., Tabanus spp., Musca spp., Hydrotaea spp., Muscina spp., Haematobosca spp., Haematobia spp., Stomoxys spp., Fannia spp., Glossina spp., Lucilia spp., Calliphora spp., Auchmeromyia spp., Cordylobia spp., Cochliomyia spp., Chrysomyia spp., Sarcophaga spp., Wohlfartia spp., Gasterophilus spp., Oesteromyia spp., Oedemagena spp., Hypoderma spp., Oestrus spp., Rhinoestrus spp., Melophagus spp., Hippobosca spp.

from the order of the Siphonaptera, for example, Ctenocephalides spp., Echidnophaga spp., Ceratophyllus spp., Pulex spp.

from the order of the Metastigmata, for example, Hyalomma spp., Rhipicephalus spp., Boophilus spp., Amblyomma spp., Haemaphysalis spp., Dermacentor spp., Ixodes spp., Argas spp., Ornithodorus spp., Otobius spp.;

from the order of the Mesostigmata; for example, Dermanyssus spp., Ornithonyssus spp., Pneumonyssus spp.

from the order of the Prostigmata, for example, Cheyletiella spp., Psorergates spp., Myobia spp., Demodex spp., Neotrombicula spp.;

from the order of the Astigmata, for example, Acarus spp., Myocoptes spp., Psoroptes spp., Chorioptes spp., Otodectes spp., Sarcoptes spp., Notoedres spp., Knemidocoptes spp., Neoknemidocoptes spp., Cytodites spp., Laminosioptes spp.

In accordance with the invention, the compositions are used for repelling arthropods, preferably ticks, fleas, midges and flies, in animals, in particular warm-blooded species. The use on humans is also possible.

Examples of animals are breeding animals or livestock: mammals such as cattle, horses, sheep, pigs, goats, camels, water buffaloes, donkeys, rabbits, fallow deer, reindeer, fur bearers such as mink, chinchilla, racoon; birds such as, for example, chickens, geese, turkeys, ducks and ostriches.

They are furthermore laboratory animals and experimental animals such as, for example, mice, rats, guinea pigs, golden hamsters, dogs and cats.

The use in pets such as, for example, dogs and cats, is especially preferred.

Since, as a rule, the treated animals also disperse a certain amount of the composition employed in the environment, for example by rubbing or together with debris, the compositions according to the invention may act not only directly on the animal but, correspondingly, also in their environment.

Naturally, the compositions used in accordance with the invention may additionally comprise other suitable active compounds in addition to the abovementioned active compounds.

Examples which may be mentioned are growth-inhibitory active compounds and synergists, for example pyriproxyfen {2-[1-methyl-2-(4-phenoxyphenoxy)-ethoxy]-pyridine CAS No.: 95737-68-1}, methoprene [(E,E)-1-methylethyl 11-methoxy-3,7,11-trimethyl-2,4-dodecadienoate CAS No.: 40596-69-8] and triflumuron {2-chloro-N-[[[4-(trifluoromethoxy)phenyl]amino]-carbonyl]benzamide CAS No.: 64628-44-0}.

The addition of further substances with a repellent effect, such as DEET (Diethyltoluamide), Bayrepel® (CAS name: 1-piperidinecarboxylic acid, 2-(2-hydroxyethyl)-, 1-methylpropyl ester), 2-(octylthio)ethanol or ethyl 3-(N-acetyl-N-butylamino)propionate is also feasible.

The application to the animal is, as a rule, via the dermal route, either directly or in the form of suitable preparations.

Since the repellent mechanism of the pyrethroids/pyrethrins requires the possibility of coming into contact with the active compound, it is recommended to distribute the active compounds over the entire surface to be protected, for example on all body parts of the animals treated. Penetration of the active compounds through the skin tends to be disadvantageous for the repellent effect since the active compounds which have penetrated the skin are no longer available for a repellent action.

Dermal application is carried out for example in the form of spraying, pouring on and spotting on.

Suitable preparations are:

solutions or concentrates for application after dilution for use on the skin or in body cavities, pour- and spot-on formulations, gels;

emulsions and suspensions, semisolid preparations;

formulations in which the active compound is incorporated into an ointment base or into an oil-in-water or water-in-oil emulsion base;

solid preparations, such as powders, premixes or concentrates, granules, pellets, aerosols and active-compound-containing shaped articles.

Solvents which may be mentioned are: physiologically acceptable solvents such as water, alcohols such as ethanol, butanol, benzyl alcohol, glycerol, propylene glycol, polyethylene glycols, N-methylpyrrolidone, 2-pyrrolidone, and mixtures of these.

If appropriate, the active compounds can also be dissolved in physiologically acceptable vegetable oils or synthetic oils.

Solubilizers which may be mentioned are: solvents which promote the dissolution of the active compound in the main solvent or prevent its precipitation. Examples are polyvinylpyrrolidone, polyvinyl alcohol, polyethoxylated castor oil, polythoxylated sorbitan esters.

Preservatives are: benzyl alcohol, trichlorobutanol, esters of p-hydroxybenzoic acid, n-butanol.

Solutions can be administered directly. Concentrates are used after prior dilution to the use concentration.

Solutions can be spotted on, pointed on, rubbed in, squirted or sprayed on to the skin.

It may be advantageous to add thickeners during preparation. Thickeners are: inorganic thickeners such as bentonites, colloidal silica, aluminium monostearate, organic thickeners such as cellulose derivatives, polyvinyl alcohols and their copolymers, acrylates and methacrylates.

Gels are applied to or painted onto the skin or introduced into body cavities. Gels are prepared by mixing solutions, which have been prepared as described in connection with the injection solutions, with sufficient thickener to form a clear composition with an ointment-like consistency. Thickeners employed are the thickeners indicated further above.

Pour-on and spot-on formulations are poured or squirted onto limited areas of the skin, the active compound penetrating the skin and acting systemically.

Pour-on-and-spot-on formulations are prepared by dissolving, suspending or emulsifying the active compound in suitable skin-tolerable solvents or solvent mixtures. If appropriate, further auxiliaries such as colorants, absorption-promoting substances, antioxidants, sunscreen agents and/or adherents are added.

Solvents which may be mentioned are: water, alkanols, glycols, polyethylene glycols, polypropylene glycols, glycerol, aromatic alcohols such as benzyl alcohol, phenylethanol, phendxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, n-alkylpyrrolidones such as n-methylpyrrolidone, n-butyl- or n-octylpyrrolidone, N-methylpyrrolidone, 2-pyrrolidone, 2,2-dimethyl-4-oxymethylene-1,3-dioxolane and glycerine formal.

Colorants are all colorants approved for use on animals and which can be dissolved or suspended.

Absorption-promoting substances are, for example, DMSO, spreading oils such as isopropyl myristate, dipropylene glycol pelargonate, silicone oils, or their copolymers with polyethers, or esters of fatty acids, triglycerides, fatty alcohols.

Antioxidants are sulphites or metabisulphites such as potassium metabisulphite, ascorbic acid, butylhydroxytoluene, butylhydroxyanisole, tocopherol.

Sunscreen agents are, for example, novantisolic acid.

Adherents are, for example, cellulose derivatives, starch derivatives, polyacrylates, natural polymers such as alginates, gelatine.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, further auxiliaries such as colorants, absorption-promoting substances, preservatives, antioxidants, sunscreen agents, thickeners.

Hydrophobic phases (oils) which may be mentioned are: paraffin oils, silicone oils, natural vegetable oils such as sesame seed oil, almond oil, castor oil, synthetic triglycerides such as caprylic/capric acid biglyceride, triglyceride mixture with vegetable fatty acids of chain length C₈₋₁₂ or other specially selected natural fatty acids, partial glyceride mixtures of saturated or unsaturated fatty acids possibly also containing hydroxyl groups, mono- and diglycerides of the C₈/C₁₀ fatty acids.

Esters of fatty acids such as ethyl stearate, di-n-butyryl adipate, hexyl laurate, dipropylene glycol pelargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, oleyl oleate, decyl oleate, ethyl oleate, ethyl lactates, waxy fatty acid esters such as synthetic duck uropygeal gland fat, dibutyl phthalate, diisopropyl adipate, ester mixtures related to the latter including, Fatty alcohols such as isotridecyl alcohol, 2-octyldodecanol, cetylstearyl alcohol, oleyl alcohol.

Fatty acids such as, for example, oleic acid and its mixtures.

Hydrophilic phases which may be mentioned are:

water, alcohols such as, for example, propylene glycol, glycerol, sorbitol and their mixtures.

Emulsifiers which may be mentioned are: nonionic surfactants, e.g. polyethoxylated castor oil, polyethoxylated sorbitan monooleate, sorbitan monostearate, glycerol monostearate, polyoxyethyl stearate, alkylphenyl polyglycol ethers;

ampholytic surfactants such as disodium N-lauryl-β-iminodipropionate or lecithin;

anionic surfactants, such as sodium lauryl sulphate, fatty alcohol ether sulphates, mono/dialkyl polyglycol ether orthophosphate monoethanolamine salt;

cationic surfactants such as cetyltrimethylammonium chloride.

Further auxiliaries which may be mentioned are: thickening and emulsion-stabilizing substances such as carboxymethylcellulose, methylcellulose and other cellulose and starch derivatives, polyacrylates, alginates, gelatine, gum arabic, polyvinylpyrrolidone, polyvinyl alcohol, copolymers of methyl vinyl ether and maleic anhydride, polyethylene glycols, waxes, colloidal silica or mixtures of the substances mentioned.

Suspensions are prepared by suspending the active compound in an excipient fluid, if appropriate, with addition of further auxiliaries such as wetting agents, colorants, absorption-promoting substances, preservatives, antioxidants, sunscreen agents.

Excipient fluids which may be mentioned are all homogeneous solvents and solvent mixtures.

Wetting agents (dispersing agents) which may be mentioned are the surfactants indicated further above.

Further auxiliaries which may be mentioned are those indicated further above.

Semi-solid preparations differ from the suspensions and emulsions described above only by their higher viscosity.

To prepare solid preparations, the active compound is brought into the desired form by mixing with suitable excipients, if appropriate with addition of auxiliaries.

Excipients which may be mentioned are all physiologically tolerable solid inert substances. Those which are used are inorganic and organic substances. Inorganic substances are, for example sodium chloride, carbonates such as calcium carbonate, hydrogen carbonates, aluminium oxides, titanium oxide; silicas, argillaceous earths, precipitated or colloidal silica, phosphates.

Organic substances are, for example, sugar, cellulose, foodstuffs and feedstuffs such as powdered milk, animal meals, fine or coarse cereal meals, starches.

Auxiliaries' are preservatives, antioxidants and colorants which have already been mentioned further above.

Further suitable auxiliaries are lubricants and glidants such as, for example, magnesium stearate, stearic acid, talc, bentonites, disintegrants such as starch or crosslinked polyvinylpyrrolidone, binders such as, for example, starch, gelatine or linear polyvinylpyrrolidone and also dry binders such as microcrystalline cellulose.

The active compounds can also be present in the preparations as a mixture with synergists or with other active compounds which are active against pathogenic endoparasites.

Especially suitable, in particular for permethrin-containing compositions, are the formulations described in WO 02/087338.

They contain: N-methylpyrrolidone in an amount of from 27.5 to 62.5% by weight, preferably from 35 to 50% by weight, especially preferably from 40 to 45% by weight.

Antioxidants in an amount of from 0-0.5% by weight, preferably from 0.05-0.25% by weight, especially preferably from 0.05-0.15% by weight. All the customary antioxidants are suitable, with phenolic antioxidants such as, for example, butylhydroxytoluene, butylhydrokyanisole, toccpherol being preferred.

Organic acid in an amount of from 0-0.5% by weight, preferably from 0.05-0.25% by weight, especially preferably from 0.05-0.15% by weight. All pharmaceutically acceptable organic acids, in particular carboxylic acids such as, for example, citric acid, tartaric acid, lactic acid, succinic acid and malic acid, are suitable for use. Especially preferred are the organic acids citric acid and malic acid. Citric acid is very especially preferred. The amount of citric acid can be varied in particular in the range of from 0.05 to 0.25, with amounts in the range of from 0.075-0.15% being especially preferred, in turn.

Cosolvents in an amount of from 2.5-10% by weight, preferably from 2.5-7.5% by weight, especially preferably from 3.5-6.0% by weight.

Suitable cosolvents are organic solvents with a boiling point of >80° C. and a flash point of >75° C. Preferably, the cosolvents act as spreaders. In this context, mention may be made of higher-boiling aliphatic and aromatic alcohols, aliphatic polyethers, aliphatic and/or aromatic esters, cyclic and/or acyclic carbonates.

Cosolvents which are employed are preferably aliphatic acyclic or cyclic ethers or polyethers, and fatty acid esters, in particular triglycerides.

Mention may be made by way of example of ethers or polyethers, for example from the series diethylene glycol monoethyl ether, dipropylene glycol monomethyl ether, tetrahydrofurfuryl alcohol and tetrahydrofurfuryl ethoxylate, where the two last-mentioned substances are to be preferred in particular; fatty acid esters and triglycerides, for example isopropyl myristate, Miglyol 810, Miglyol 812, Miglyol 818, Miglyol 829, Miglyol 840 and Miglyol 8810 (for the definition of the Miglyols, see, for example, H. P. Fiedler Lexikon der Hilfsstoffe für Pharmazie, Kosmetik und angrenzende Gebiete [Dictionary of the auxiliaries for pharmacology, cosmetology and related fields], pages 1008-1009, Vol. 2, Edito Cantor Verlag Aulendorf (1996)).

The compositions which are modified with the abovementioned cosolvents are distinguished by the fact that they are very well tolerated by the skin and the eyes, their excellent biological activity and their advantageous low-temperature-stability behaviour in the customary single-dose application tubes.

In addition to the abovementioned components, the compositions according to the invention can contain further customary pharmaceutically acceptable auxiliaries. Those which may be mentioned by way of example are spreaders and surfactants.

Spreaders are, for example, spreading oils such as di-2-ethylhexyl adipate, isopropyl myristate; dipropylene glycol perlargonate, cyclic and acyclic silicone oils such as dimethicones, and further their copolymers and terpolymers with ethylene oxide and propylene oxide and formalin, fatty acid esters, triglycerides, fatty alcohols.

Surfactants which may be mentioned are: nonionic surfactants, for example polyoxyethylated castor oil, polyoxyethylated sorbitan monooleate, sorbitan monostearate, glycerol monostearate, polyoxyethyl stearate, alkylphenyl polyglycol ethers;

ampholytic surfactants such as disodium N-lauryl-β-iminodipropionate or lecithin;

anionic surfactants such as sodium lauryl sulphate, fatty alcohol ether sulphates, mono/dialkyl polyglycol ether orthophosphate monoethanolamine salt;

cationic surfactants such as cetyltrimethylammonium chloride.

The compositions used in accordance with the invention can be prepared by customary methods, for example by mixing the active compounds with the further constituents, with stirring, and making a solution. If appropriate, this solution can be filtered. It can be packaged for example into plastic tubes.

The preferred application volumes for the formulations described in WO002/087338 are 0.075-0.25 ml/1.0 kg [body weight of the animal to be treated], preferably 0.1-0.15 mV/1.0 kg [body weight of the animal to be treated].

They are outstandingly suitable for packaging and selling in storage-critical containers such as, for example, the single-dose polypropylene polymer tubes which have a wall thickness of 300-500 μm and a filling volume of 1.0-4.0 ml.

Moreover, the compositions are very skin-friendly, have low toxicity and are, owing to the fact that they are biodegradable, environmentally friendly.

### EXAMPLES

### Example 1

A homogeneous spot-on solution comprising
45 g permethrin comprising 40% cis and 60% trans isomers
10 g imidacloprid (1-[(6-chloro-3-pyridinyl)methyl]-N-nitro-2-imidazolidinimine) from Bayer AG
44.8 g N-methylpyrrolidone
0.1 g citric acid
0.1 g BHT (butylhydroxytoluene)

### Example 2

A homogeneous spot-on solution comprising
45 g permethrin comprising 40% cis and 60% trans isomers
10 g imidacloprid
40.8 g N-methylpyrrolidone
4.0 g water
0.1 g citric acid
0.1 g BHT

### Example 3

A homogeneous spot-on solution comprising
45 g permethrin comprising 40% cis and 60% trans isomers
10 g Ti 435, chlothianidine from Takeda AG
44.8 g N-methylpyrrolidone
0.1 g citric acid
0.1 g BHT

### Example 4

A homogeneous spot-on solution comprising
45 g permethrin comprising 40% cis and 60% trans isomers
10 g diacloden (thiamethoxam) from Syngenta AG
44.8 g N-methylpyrrolidone
0.1 g citric acid
0.1 g BHT

### Example 5

A homogeneous spot-on solution comprising
45 g permethrin comprising 40% cis and 60% trans isomers
10 g spinosad (8.5 g spinosyn A; 1.5 g spinosyn D) from Dow Agrosciences
44.8 g N-methylpyrrolidone
0.1 g citric acid
0.1 g BHT

### Example 6

A homogeneous spot-on solution comprising
45 g permethrin comprising 40% cis and 60% trans isomers
20 g nithiazine from Shell AG
34.8 g N-methylpyrrolidone
0.1 g citric acid
0.1 g BHT

### Example 7

A homogeneous spot-on solution comprising
45 g permethrin comprising 40% cis and 60% trans isomers
10 g Ti 435, chlothianidine from Takeda AG
39.8 g N-methylpyrrolidone
0.1 g citric acid
0.1 g BHT.
5.0 g tetrahydrofurfuryl alcohol

### Example 8

A homogeneous spot-on solution comprising
45 g permethrin comprising 40% cis and 60% trans isomers
10 g diacloden (thiamethoxam) from Syngenta AG
39.8 g N-methylpyrrolidone
0.1 g citric acid
0.1 g BHT
5.0 g tetrahydrofurfuryl ethoxylate

### Example 9

A homogeneous spot-n solution comprising
45 g permethrin comprising 40% cis and 60% trans isomers
10 g spinosad (8.5 g spinosyn A; 1.5 g spinosyn D from Dow Agrosciences
39.8 g N-methylpyrrolidone
0.1 g citric acid
0.1 g BHT
5.0 g tetrahydrofurfuryl ethoxylate

### Example 10

A homogeneous spot-on solution comprising
45 g permethrin comprising 40% cis and 60% trans isomers
20 g nithiazine from Shell AG
29.8 g N-methylpyrrolidone
0.1 g citric acid
0.1 g BHT
5.0 g tetrahydrofurfuryl ethoxylate

### Example 11

A homogeneous spot-on solution comprising
10 g α-cypermethrin
10 g imidacloprid
79.8 g N-methylpyrrolidone
0.1 g citric acid.
0.1 g BHT (butylhydroxytoluene)

### Example 12

A homogeneous spot-on solution comprising
10 g α-cypermethrin
30.10 g imidacloprid
75.8 g N-methylpyrrolidone
4.0 g water
0.1 g citric acid
0.1 g BHT

### Example 13

A homogeneous spot-on solution comprising
10 g α-cypermethrin
10 g Ti 435, chlothianidine, from Takeda AG
79.8 g N-methylpyrrolidone
0.1 g citric acid
0.1 g BHT

### Example 14

A homogeneous spot-on solution comprising
10 g α-cypermethrin
10 g diacloden (thiamethoxam) from Syngenta AG
79.8 g N-methylpyrrolidone
0.1 g citric acid
0.1 g BHT

### Example 15

A homogeneous spot-on solution comprising
10 g α-cypermethrin
10 g spinosad (8.5 g spinosyn A; 1.5 g spinosyn D) from Dow Agrosciences
79.8 g N-methylpyrrolidone
0.1 g citric acid
0.1 g BHT

### Example 16

A homogeneous spot-on solution comprising
10 g α-cypermethrin
20 g nithiazine from Shell AG
69.8 g N-methylpyrrolidone
0.1 g citric acid
0.1 g BHT

### Example 17

A homogeneous spot-on solution comprising
10 g α-cypermethrin
10 g Ti 435, chlothianidine, from Takeda AG
74.8 g N-methylpyrrolidone
0.1 g citric acid
0.1 g BHT
5.0 g tetrahydrofurfuryl alcohol

### Example 18

A homogeneous spot-on solution comprising
10 g α-cypermethrin
10 g diacloden (thiamethoxam) from Syngenta AG
74.8 g N-methylpyrrolidone
0.1 g citric acid
0.1 g BHT
5.0 g tetrahydrofurfuryl ethoxylate

### Example 19

A homogeneous spot-on solution comprising
10 g α-cypermethrin
10 g spinosad (8.5 g spinosyn A; 1.5 g spinosyn D) from Dow Agrosciences
74.8 g N-methylpyrrolidone
0.1 g citric acid
0.1 g BHT
5.0 g tetrahydrofurfuryl ethoxylate

### Example 20

A homogeneous spot-on solution comprising
10 g α-cypermethrin
20 g nithiazine from Shell AG
64.8 g N-methylpyrrolidone
0.1 g citric acid
0.1 g BHT
5.0 g tetrahydrofurfuryl ethoxylate

### Example 21

A homogeneous spot-on solution comprising
45 g etofenprox
10 g imidacloprid
44.8 g N-methylpyrrolidone
0.1 g citric acid
0.1 g BHT (butylhydroxytoluene)

### Example 22

A homogeneous spot-on solution comprising
45 g etofenprox
10 g imidacloprid
40.8 g N-methylpyrrolidone
4.0 g water
0.1 g citric acid
0.1 g BHT

### Example 23

A homogeneous spot-on solution comprising
45 g etofenprox
10 g Ti 435, chlothianidine, from Takeda AG
44.8 g N-methylpyrrolidone
0.1 g citric acid
0.1 g BHT

### Example 24

A homogeneous spot-on solution comprising
45 g etofenprox
10 g diacloden (thiamethoxam) from Syngenta AG
44.8 g N-methylpyrrolidone
0.1 g citric acid
0.1 g BHT

### Example 25

A homogeneous spot-on solution comprising
45 g Etofenprox
10 g spinosad (8.5 g spinosyn A; 1.5 g spinosyn D) from Dow Agrosciences
44.8 g N-methylpyrrolidone
0.1 g citric acid
0.1 g BHT

### Example 26

A homogeneous spot-on solution comprising
45 g etofenprox
20 g nithiazine from Shell AG
34.8 g N-methylpyrrolidone
0.1 g citric acid
0.1 g BHT

### Example 27

A homogeneous spot-on solution comprising
45 g etofenprox
10 g Ti 435, chlothianidine, from Takeda AG
39.8 g N-methylpyrrolidone
0.1 g citric acid
0.1 g BHT
5.0 g tetrahydrofurfuryl alcohol

### Example 28

A homogeneous spot-on solution comprising
45 g etofenprox
10 g diacloden (thiamethoxam) from Syngenta AG
39.8 g N-methylpyrrolidone
0.1 g citric acid
0.1 g BHT
5.0 g tetrahydrofurfuryl ethoxylate

### Example 29

A homogeneous spot-on solution comprising
45 g etofenprox
10 g spinosad (8.5 g spinosyn A; 1.5 g spinosyn D) from Dow Agrosciences
39.8 g N-methylpyrrolidone
0.1 g citric acid
0.1 g BHT
5.0 g tetrahydrofurfuryl ethoxylate

### Example 30

A homogeneous spot-on solution comprising
45 g etofenprox
20 g nithiazine from Shell AG
29.8 g N-methylpyrrolidone
0.1 g citric acid
0.1 g BHT
5.0 g tetrahydrofurfuryl ethoxylate

### Example 31

A homogeneous spot-on solution comprising
45 g pyrethrum extract
10 g imidacloprid
44.8 g N-methylpyrrolidone
0.1 g citric acid
0.1 g BHT (butylhydroxytoluene)

### Example 32

A homogeneous spot-on solution comprising
45 g pyrethrum extract
10 g imidacloprid
40.8 g N-methylpyrrolidone
4.0 g water
0.1 g citric acid
0.1 g BHT

### Example 33

A homogeneous spot-on solution comprising
45 g pyrethrum extract
10 g Ti 435, chlothianidine, from Takeda AG
44.8 g N-methylpyrrolidone
0.1 g citric acid
0.1 g BHT

### Example 34

A homogeneous spot-on solution comprising
45 g pyrethrum extract
10 g diacloden (thiamethoxam) from Syngenta AG
44.8 g TN-methylpyrrolidone
0.1 g citric acid
0.1 g BHT

### Example 35

A homogeneous spot-on solution comprising
45 g pyrethrum extract
10 g spinosad (8.5 g spinosyn A; 1.5 g spinosyn D) from Dow Agrosciences
44.8 g N-methylpyrrolidone
0.1 g citric acid
0.1 g BHT

### Example 36

A homogeneous spot-on solution comprising
45 g pyrethrum extract
20 g nithiazine from Shell AG
34.8 g N-methylpyrrolidone
0.1 g citric acid
0.1 g BHT

### Example 37

A homogeneous spot-on solution comprising
45 g pyrethrum extract
10 g Ti 435, chlothianidine, from Takeda AG
39.8 g N-methylpyrrolidone
0.1 g citric acid
0.1 g BHT
5.0 g tetrahydrofurfuryl alcohol

### Example 38

A homogeneous spot-on solution comprising
45 g pyrethrum extract
10 g diacloden (thiamethoxam) from Syngenta AG
39.8 g N-methylpyrrolidone
0.1 g citric acid
0.1 g BHT
5.0 g tetrahydrofurfuryl ethoxylate

### Example 39

A homogeneous spot-on solution comprising
45 g pyrethrum extract
10 g spinosad (8.5 g spinosyn A; 1.5 g spinosyn D) from Dow Agrosciences
39.8 g N-methylpyrrolidone
0.1 g citric acid
0.1 g BHT
5.0 g tetrahydrofurfuryl ethoxylate

### Example 40

A homogeneous spot-on solution comprising
45 g pyrethrum extract
20 g nithiazine from Shell AG
29.8 g N-methylpyrrolidone
0.1 g citric acid
0.1 g BHT
5.0 g tetrahydrofurfuryl ethoxylate
   A. Repellation of Ticks in the Moving-Object Bioassay. Comparison with the Prior Art
   Method

Moving-object bioassay by the method of Dautel et al. (1999)

Brief description: individual ticks approach a warmed, slowly rotating, vertical cylinder on a horizontally mounted glass rod. The ticks are attracted by the heat of the cylinder and migrate onto an attachment site on the rotating cylinder. If a repellent is applied to this attachment site, the repellent effect can be measured either i) on the basis of a decreasing number of ticks which migrate towards the cylinder, or ii) by a reduced number of ticks which migrate onto the attachment site, or iii) by an increasing number of ticks which drop prematurely off the attachment site. A cylinder with an untreated control acts as comparison. Both contact repellents and distant-acting repellents can be measured.

Test Conditions:

Each test is carried out with 30 ticks. All the ticks are tested individually one after the other in the same apparatus. For each test series, a control test with pure solvent without repellent is carried out to check the basal activity of the ticks. The critical activity for carrying out a test is the migration of at least 70% of the ticks onto the cylinder. A separate test cylinder is used for each test product. After each test series, all of the equipment used is cleaned carefully.

The following conditions were established for testing Ixodes ricinus and Rhipicephalus sanguineus ticks.

I. ricinus:

A standard cylinder and attachment zone were used (Dautel et al. (1999)). The attachment zone was positioned 1-3 mm above the cylinder surface. The distance between the glass rod of 2 mm diameter and the attachment zone amounted to between 1 and not more than 1.5 mm.

The rotational speed of the cylinder was between 3.9 and 4.1 s/revolution, corresponding to 7.66-8.05 cm/s relative to the tick. The surface temperature at the attachment zone was between 34.6 and 35.5° C. The room temperature and the atmospheric humidity were between 19.1 and 22.3° C., and 43.4 and 78.1% r.h.

R. sanguineus:

Adult R. sanguineus move more rapidly than I. ricinus nymphs. The attachment zone on the cylinder must therefore be enlarged in such a way that a contact period of at least 10 seconds can be ensured, even for rapidly moving specimens. Thus, the entire cylinder acts as attachment site here. Owing to the poor attachment of the ticks to filter paper, the cylinder was covered in Molton cloth. The distance between Molton and glass rod (4 mm diameter) amounted to 1-3 mm, whereby the ticks were capable at any time of migrating from the glass rod to the cylinder.

The rotational speed of the cylinder was between 5.6 and 6.0 s/revolution, corresponding to 5.23-5.61 cm/s relative to the tick. The surface temperature at the attachment zone was between 35 and 36° C. The room temperature and the atmospheric humidity were between 19.4 and 23.5° C., and 59.1 and 79.5% r.h.

Application of the Test Substance

In all of the experiments, acetone was used as the solvent and for the dilutions. Application was effected 1-2 hours before the beginning of the experiment to allow sufficient time for the solvent to evaporate.

The active compounds were applied to the filter papers using a disposable pipette Uniform distribution on the larger surface of the Molton cloth was achieved with the aid of a spraying apparatus under nitrogen pressure. The precise volume applied was determined here by back-weighing.

MO Bioassay

Only those ticks which, in a glass tube, climbed actively towards the upper edge and migrated rapidly onto a badger-hair brush (0 or 1), which was used for transferring the ticks, were employed in the test. These ticks were placed on the glass rod at a distance of 1.5 cm (I. ricinus) or 2.54 cm (R. sanguineus) to the tip of the glass rod so that their heads faced the cylinder. The experimental, time started as soon as a tick had crossed the 1 cm (I. ricinus) or the 2 cm (R. sanguineus) mark on the glass rod. Ticks which were dropped from the brush or which dropped off the glass rod before reaching the marker were not included in the evaluation.

The following periods of time were recorded by means of a stop clock:
time taken from crossing the mark to reaching the end of the glass rod
time taken from reaching the tip of the glass rod to migration onto the cylinder
time for which the tick remains on the filter or on the Molton cloth until it drops off or leaves the treated area.

A maximum of 120 seconds was envisaged for each of these periods of time. After 2 minutes, the tick was removed, and the period of time was evaluated at 120 seconds.

A total repellent effect relative to the control was calculated by adding all the ticks which did not move towards the cylinder, which did not migrate to the cylinder and which dropped off the attachment zone. All of these ticks were evaluated as repelled. The repellent effect is calculated as follows:
R=100−pt/pc*100,
where R is the repellent effect, pt the percentage of unrepelled ticks and pc the percentage of the unrepelled control ticks.

Results from Repellent Experiments with Rhipicephalus sanguineus Ticks—Comparison with the Prior Art (Exspot®, from Schering-Plough)

TABLE 1a
R. sanguineus: residence time [s] on the treated cylinder surface.

| Formulation (dosage) | n | Composition | SD | 95% Conf. |
|---|---|---|---|---|
| Control | 25 | 83.8 | 39.7 | 67.4-100.2 |
| Example 1 (17/83 μg/cm²)*) | 18 | 5.5 | 3.9 | 3.6-7.5 |
| Exspot ® (83.3 μg/cm²) | 20 | 21.9 | 30.3 | 7.7-36.0 |

*)The first value refers to the amount of imidacloprid and the second to the amount of permethrin

Surprisingly, the formulation of Example 1 displays a markedly more pronounced repellent effect than the standard (Exspot® contains permethrin as the only active compound). In Example 1, ticks which migrate onto the cylinder drop off much more rapidly than in the case of the standard. In the present example, the repellent effect of the standard is enhanced on average by a factor of 4.

TABLE 1b
R. sanguineus: time taken [s] until the ticks migrate
from the tip of the glass rod to the cylinder.

| Formulation (dosage) | n | Composition | SD | 95% Conf. |
|---|---|---|---|---|
| Control | 30 | 3.5 | 6.2 | 1.2-5.8 |
| Example 1 (17/83 μg/cm²)*) | 30 | 7.9 | 22.1 | 0.3-16.2 |
| Exspot ® (83.3 μg/cm²) | 27 | 2.8 | 6.9 | 0.0-5.5 |

*)The first value refers to the amount of imidacloprid and the second to the amount of permethrin

A further sign for the improved repellent effect is the delayed migration from the glass rod onto the cylinder. Again, it was established that ticks in Example 1 take on average three times longer in comparison with the standard. The standard here is within a control range.

TABLE 2
R. sanguineus: evaluation of the MO biotest: formulation
according to the invention and prior art (Exspot ®,
from Schering-Plough) versus control

| | Dose | | | |
|---|---|---|---|---|
| | | Example 1 | | Exspot ® |
| | Control | 16.6/83.1 μg/cm² | Control | 8.3 μg/cm² |
| Unrepelled ticks | 27 | 0 | 25 | 3 |
| Repelled ticks | 3 | 30 | 5 | 27 |
| % not repelled | 90.0 | 0.0 | 83.3 | 10 |
| Repellent effect | | 100.0 | | 88.0 |
| [% of the control] | | | | |

It was established that the formulation according to the invention of Example 1 has a 100% repellent effect in the relevant dose range in comparison with the respective control in the case of a formulation distributed uniformly topically with spot-on application. Surprisingly, the known commercial product is not capable of repelling all of the ticks under identical conditions.

Results from Repellent Experiments with Ixodes ricinus Ticks, Comparison with the Prior Art (Exspot®, from Schering-Plough)

TABLE 3
I. ricinus: evaluation of the MO biotest: formulation according to the invention
and prior art (Exspot ®, from Schering-Plough) versus controls

| Formulation/dosage | | Example 1 (according to the invention) | | | | |
|---|---|---|---|---|---|---|
| Behaviour parameters | Control | 1.9/9.3 μg/cm² | 5/25 μg/cm² | 19/93 μg/cm² | 190/930 μg/cm² | Control |
| Unrepelled ticks | 28 | 20.5 | 17 | 18 | 15 | 27 |
| Repelled ticks | 2 | 9.5 | 13 | 12 | 15 | 3 |
| % not repelled | 93.3 | 6.3 | 56.7 | 60.0 | 50.0 | 90.0 |
| Repellent effect [%] | | 25.3 | 39.3 | 33.3 | 44.4 | |

| Formulation/dosage | | Exspot ® | | | | |
|---|---|---|---|---|---|---|
| Behaviour parameters | Control | 9.3 μg/cm² | 25 μg/cm² | 93 μg/cm² | 930 μg/cm² | Control |
| Unrepelled ticks | 26 | 24 | 22 | 18 | 15 | 28 |
| Repelled ticks | 4 | 6 | 8 | 12 | 15 | 2 |
| % not repelled | 86.7 | 80.0 | 73.3 | 60.0 | 50.0 | 93.3 |
| Repellent effect [%] | | 7.7 | 21.4 | 30.8 | 42.3 | |

Surprisingly, a markedly improved repellent effect was established for the example according to the invention even in the case of Ixodes, a tick which is not repelled efficiently by Exspot®. In particular at low dosage rates as can be expected at the beginning of the treatment on body surfaces which are further away from the application site of the spot-on and on all of the animal at the end of the duration of action, the example according to the invention reveals repellency in the same range as at the higher dosage rates, while the curve of the repellent effect in the prior art has already dropped by a factor of 6.

Thus, formulations according to the invention at the same application rate reveal a markedly improved repellent effect on ticks versus the prior art in the important parameters probability for migration onto the surface, residence time on the surface and efficacy at lower dosage rates.

B. Mortality of Ticks in the Moving-Object Bioassay.

Method

Determination of the final mortality after short-time contact in the moving-object bioassay

Summary: after exposure, the ticks were transferred individually into Eppendorf tubes with a pierced lid and stored at 90% r.h. and 20° C. After 24 hours and after 7 days, the ticks were studied by means of a stereoscope. Ticks which were capable of coordinated movement were considered as being alive. Ticks which performed only minor movements with the tarsi or mouth parts or which were incapable of running were considered as moribund. Ticks which remained immobile after a CO₂ stimulus or after a strong light pulse were considered as being dead.

The aim of the studies was to reveal any connection between the exposure time (=residence time on the treated cylinder surface during an MO bioassay) and the mortality at different concentrations of different formulations in comparison with the prior art.

TABLE 1
R. sanguineus: mortality (d 7) and contact times at various
concentrations of test formulations in the MO bioassay.

| | Dosage rate | | Mortality | | Contact time [s] | | |
|---|---|---|---|---|---|---|---|
| Formulation | (a.i.) | | n | % | Mean | SD | 95% Conf. |
| Example 1 | 16.6/83.1 | μg/cm² | 21 | 70% | 4.2 | 4.4 | 2.2-6.2 |
| Exspot ® | 83.3 | μg/cm² | 16 | 53% | 24.7 | 33.5 | 6.9-42.6 |

TABLE 2
I. ricinus: mortality (d 7) and contact times at various concentrations
of test formulations in the MO bioassay.

| | Dosage rate | | Mortality | | Contact time [s] | | |
|---|---|---|---|---|---|---|---|
| Formulation | (a.i.) | | n | % | Mean | SD | 95% Conf. |
| Example 1 | 19/93 | μg/cm²*) | 27 | 90 | 33.7 | 30.6 | 21.6-45.9 |
| Exspot ® | 93 | μg/cm² | 26 | 87 | 41.9 | 31.1 | 29.3-54.4 |

*)The first value refers to the amount of imidacloprid and the second value to the amount of permethrin

The kill rate of both Ixodes and Rhipicephalus ticks is higher after contact with the cylinder surface. The mean contact time required for this higher mortality was even shorter in formulations according to the invention than in the prior art.

Thus, the formulations according to the invention provide additional protection by the fact that repelled ticks are killed even after short contact times of markedly less than one minute so that other hosts can no longer be attacked by repelled ticks.

1. A method for repelling arthropods from warm-blooded species, locations, and/or materials comprising the step of applying an effective amount of a pyrethroid or pyrethrin in combination with a nicotinic agonist to said warm-blooded species, locations, and/or materials.

2. The method according to claim 1, wherein the pyrethroid is selected from the following groups:
I. Type I pyrethroids
II. Type II pyrethroids
III. Non-ester-pyrethroids
IV. Natural pyrethrins.

3. The method according to claim 1, wherein the nicotinic agonist is selected from the following groups:
V. Neonicotinoids
VI. Nithiazine
VII. Spinosyns.

4. The method according to claim 1, wherein said arthropods are selected from ticks, fleas, midges and/or flies.

5. A method for repelling arthropods from warm-blooded species, comprising the step of topically applying an effective amount of a pyrethroid or pyrethrin in combination with a nicotinic agonist to the warm-blooded animal.

6. Method for repelling arthropods from locations and materials where they are undesired, in which a pyrethroid or pyrethrin in combination with a nicotinic agonist is applied to the location or the material from which the arthropods are to be repelled.
